(19) United States
(12) Patent Application Publication
(10) Pub. No.: US 2009/0309688 A1
(43) Pub. Date: Dec. 17, 2009

(54) Circuit apparatus and method of manufacturing the same

(75) Inventor: Masaya Kawano, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/453,512

(22) Filed: May 13, 2009

(30) Foreign Application Priority Data
Jun. 17, 2008 (JP) 2008-157463

(51) Int. Cl. H01F 5/00; H01F 41/04

(52) U.S. Cl. 336/200; 29/602.1

(57) ABSTRACT

A circuit apparatus includes a first insulating layer, a first inductor, a first terminal, a second terminal, a first interconnect, and a wire. The first inductor is located at one surface of the first insulating layer and configured by a spiral conductive pattern. The first terminal and the second terminal are exposed from one surface of the first insulating layer. The first interconnect is formed on one surface of the first insulating layer to connect the first terminal and an external end of the first inductor. The wire is located on a one-surface side of the first insulating layer to connect the second terminal and a central end of the first inductor.

This application is based on Japanese patent application NO. 2008-157463, the content of which is incorporated hereinto by reference.

### BACKGROUND

1. Technical Field

The present invention relates to a circuit apparatus having an inductor configured by a spiral conductive pattern and a method of manufacturing the same.

2. Related Art

When electric signals are transmitted between two circuits to which electric signals having different potentials are input, a photocoupler is frequently used. The photocoupler has a light-emitting element such as a light-emitting diode and a light-receiving element such as a phototransistor. The photocoupler converts an input electric signal into light through the light-emitting element, and returns the light to an electric signal through the light-receiving element to transmit the electric signal.

However, since the photocoupler has the light-emitting element and the light-receiving element, the photocoupler cannot be easily reduced in size. Furthermore, when a frequency of the electric signal is high, the photocoupler cannot follow the electric signal. As a technique to solve these problems, for example, as described in Japanese Patent Application Laid-Open (JP-A) No. 2002-164704, a technique which inductively couples two inductors to each other to transmit an electric signal has been developed. In this technique, the inductor is a spiral interconnect, and a central end of the inductor is extracted outside by another interconnect layer.

### SUMMARY

In the above technique, when an inductor is formed by a spiral interconnect, a interconnect layer to extract a central end of the inductor outside should be formed. For this reason, the number of interconnect layers of a circuit apparatus increases, leading to an increased manufacturing cost of the circuit apparatus.

In one embodiment, there is provided a circuit apparatus including:

a first insulating layer;

a first inductor located on one surface of the first insulating layer and configured by a spiral conductive pattern;

a first terminal and a second terminal exposed from the one surface of the first insulating layer;

a first interconnect formed at the one surface of the first insulating layer to connect the first terminal and an external end of the first inductor; and

a first wire located on the one surface side of the first insulating layer to connect the second terminal and a central end of the first inductor.

According to the present invention, the second terminal and the central end of the first inductor are connected to each other by the first wire. For this reason, a interconnect layer to extract the central end out of the first inductor need not be formed. The cost of connection by a wire is lower than the cost of connection by an interconnect layer. Therefore, the number of interconnect layers of the circuit apparatus may be suppressed from increasing. As a result, the manufacturing cost of the circuit apparatus may be suppressed from increasing.

In another embodiment, there is provided a method of manufacturing a circuit apparatus, including:

forming a first insulating layer;

forming a first terminal and a second terminal exposed from the first insulating layer, a first inductor located at the first insulating layer, and an interconnect which connects an external end of the first inductor and the first terminal; and

connecting the second terminal and a central end of the first inductor by using a wire.

According to the present invention, the manufacturing cost of the circuit apparatus may be suppressed from increasing.

### BRIEF DESCRIPTION OF THE DRAWINGS

The above and other objects, advantages and features of the patent invention will be more apparent from the following description of certain preferred embodiments taken in conjunction with the accompanying drawings, in which:

FIG. 1 is a cross-sectional view of a circuit apparatus according to a first embodiment;

FIG. 2 is a plan view schematically showing the circuit apparatus shown in FIG. 1;

FIG. 3 is a cross-sectional view of a method of manufacturing the circuit apparatus-shown in FIG. 1;

FIG. 4 is a cross-sectional view of a method of manufacturing the circuit apparatus shown in FIG. 1;

FIG. 5 is a cross-sectional view of a method of manufacturing the circuit apparatus shown in FIG. 1;

FIG. 6 is a cross-sectional view showing an example of a semiconductor device using the circuit apparatus shown in FIG. 1;

FIG. 7 is a plan view of a semiconductor device according to a second embodiment;

FIG. 8 is a cross-sectional view of a circuit apparatus according to a third embodiment;

FIG. 9 is a cross-sectional view of a circuit apparatus according to a fourth embodiment;

FIG. 10 is a cross-sectional view of a circuit apparatus according to a fifth embodiment;

FIG. 11 is a plan view schematically showing the circuit apparatus shown in FIG. 10;

FIG. 12 is a cross-sectional view of a circuit apparatus according to a sixth embodiment;

FIG. 13 is a cross-sectional view of a circuit apparatus according to a seventh embodiment;

FIG. 14 is a cross-sectional view of a circuit apparatus according to an eighth embodiment;

FIG. 15 is a plan view schematically showing the circuit apparatus shown in FIG. 14;

FIG. 16 is a cross-sectional view of a circuit apparatus according to a ninth embodiment;

FIG. 17 is a cross-sectional view of a circuit apparatus according to a tenth embodiment;

FIG. 18 is a cross-sectional view of a semiconductor device shown in FIG. 17;

FIGS. 19A and 19B are cross-sectional views showing a method of manufacturing the semiconductor device shown in FIG. 18;

FIGS. 20A and 20B are cross-sectional views showing a method of manufacturing the semiconductor device shown in FIG. 18;

FIG. 21 is a cross-sectional view showing a configuration of a semiconductor device according to an eleventh embodiment;

FIG. 22 is a cross-sectional view showing a configuration of a semiconductor device according to a twelfth embodiment;

FIG. 23 is a cross-sectional view of a circuit apparatus according to a thirteenth embodiment; and

FIG. 24 is a plan view showing the circuit apparatus shown in FIG. 23.

### DETAILED DESCRIPTION

The invention will be now described herein with reference to illustrative embodiments. Those skilled in the art will recognize that many alternative embodiments can be accomplished using the teachings of the present invention and that the invention is not limited to the embodiments illustrated for explanatory purposed.

Embodiments of the present invention will be described below with reference to the accompanying drawings. The same reference numerals in all the drawings denote the same constituent elements in the drawings, and a description thereof will not be repeated.

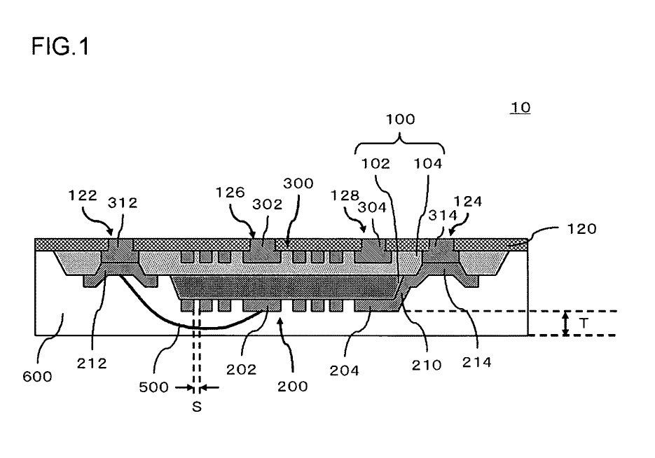

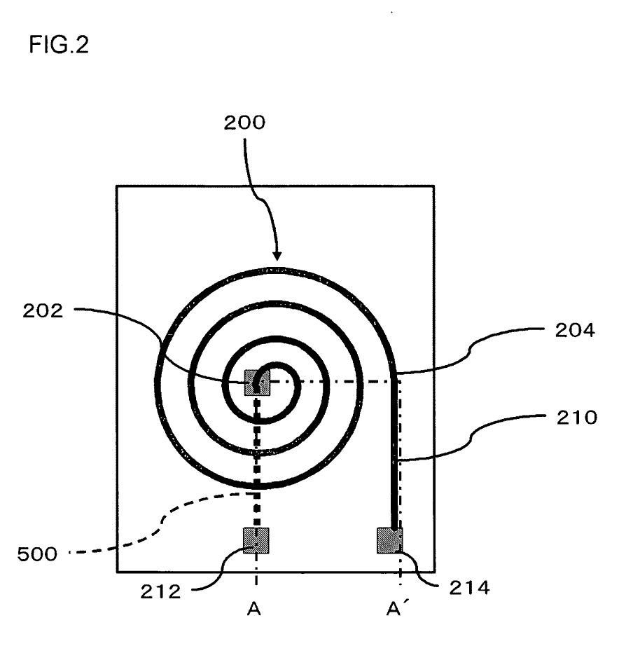

FIG. 1 is a cross-sectional view of a circuit apparatus 10 according to a first embodiment, and FIG. 2 is a plan view schematically showing the circuit apparatus 10 shown in FIG. 1. FIG. 1 corresponds to a cross-sectional view along an A-A′ line in FIG. 2. The circuit apparatus 10 includes a first insulating layer 100, a first inductor 200, a first terminal 214, a second terminal 212, a first interconnect 210, and a wire 500. The first inductor 200 is located at one surface of the first insulating layer 100 and configured by a spiral conductive pattern. The first terminal 214 and the second terminal 212 are exposed from one surface of the first insulating layer 100. The first interconnect 210 is formed at one surface of the first insulating layer 100 to connect the first terminal 214 and an external end 204 of the first inductor 200 to each other. The wire 500 is located on a one-surface side of the first insulating layer 100 to connect the second terminal 212 and a central end 202 of the first inductor 200.

The first insulating layer 100 essentially consists of, for example, a polyimide resin. The first inductor 200 essentially consists of one element selected from the group consisting of gold, copper, nickel, titanium, titanium-tungsten, and chromium, or a laminated film or an alloy containing two or more elements selected from the group. A thickness of the first insulating layer 100 is larger than an interconnect interval S (interval between conductive patterns) S of the first inductor 200.

The circuit apparatus 10 includes an sealing resin layer 600. The sealing resin layer 600 encapsulates one surface of the first insulating layer 100, the first inductor 200, the first terminal 214, the second terminal 212, the first interconnect 210, and the wire 500. The sealing resin layer 600 is, for example, an epoxy resin layer. A thickness T of the sealing resin layer 600 on the first inductor 200 is smaller than the interconnect interval S of the first inductor 200.

The circuit apparatus 10 further includes a second inductor 300, a third terminal 314, a fourth terminal 312, a second insulating layer 120, and openings 122, 124, 126, and 128. The second inductor 300 is located at the other surface of the first insulating layer 100 and located in a region overlapping the first inductor 200 in a direction perpendicular to the one surface of the first insulating layer 100. The third terminal 314 and the fourth terminal 312 are arranged at the other surface of the first insulating layer 100 and connected to the first terminal 214 and the second terminal 212, respectively. The second insulating layer 120 has one surface being in contact with the other surface of the first insulating layer 100 and the second inductor 300. The second insulating layer 120 essentially consists of, for example, a polyimide resin.

The openings 122, 124, 126, and 128 are arranged in the second insulating layer 120 to expose the fourth terminal 312, the third terminal 314, and two ends 302 and 304 of the second inductor 300 from the other surface of the second insulating layer 120, respectively. In the embodiment, the fourth terminal 312, the third terminal 314, and the two ends 302 and 304 of the second inductor 300 are buried in the openings 122, 124, 126, and 128, respectively. The other surface of the second insulating layer 120 is planar. The second inductor 300 essentially consists of one element selected from the group consisting of gold, copper, nickel, titanium, titanium-tungsten, and chromium or an alloy of two or more elements selected from the group.

The first insulating layer 100 may have a structure in which a plurality of insulating films are laminated. In the embodiment, the first insulating layer 100 has a structure in which insulating films 102 and 104 are laminated. Both the insulating films 102 and 104 essentially consist of a polyimide resin. The insulating film 102 is deposited on a center portion of the insulating film 104, and is not formed on a portion where the first terminal 214 and the second terminal 212 are located. The first inductor 200 is formed on the insulating film 102, and the first terminal 214 and the second terminal 212 are formed at the insulating film 104. The first interconnect 210 partially extends on a side surface of the insulating film 102. In the insulating film 104, openings located above the third terminal 314 and the fourth terminal 312 are formed, respectively. The first terminal 214 and the second terminal 212 are formed in the openings and on portions therearound.

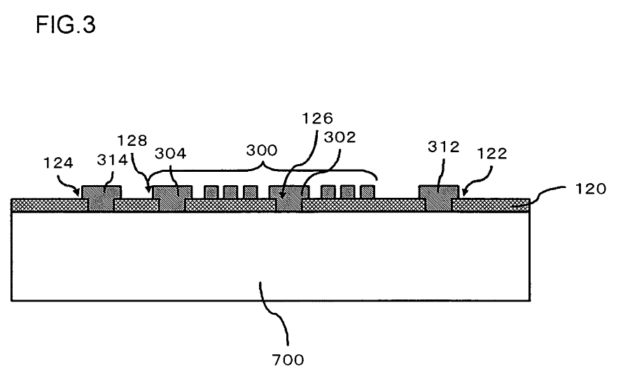

FIGS. 3, 4, and 5 are cross-sectional views showing a method of manufacturing the circuit apparatus 10 shown in FIGS. 1 and 2. As shown in FIG. 3, the second insulating layer 120 is formed on one surface of a support member 700 by a spin coating method. The support member 700 is a semiconductor substrate such as a silicon wafer and has one planar surface. The second insulating layer 120 is selectively removed to form openings 122, 124, 126, and 128.

A seed film (not shown) is deposited on the second insulating layer 120 and in the openings 122, 124, 126, and 128 by a sputtering method. A resist pattern (not shown) is formed on the seed film. By using the resist pattern as a mask, plating is performed by using the seed film as a seed. In this manner, the second inductor 300, the two ends 302 and 304 thereof, the third terminal 314, and the fourth terminal 312 are formed. Thereafter, exposed portions of the resist pattern and the seed layer are removed.

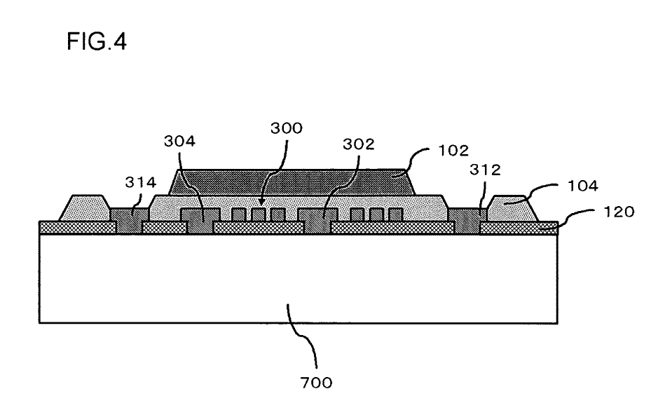

As shown in FIG. 4, on the second insulating layer 120, the second inductor 300, the third terminal 314, and the fourth terminal 312, the insulating film 104 is deposited by a spin coating method. The insulating film 104 is selectively removed to form openings, and the third terminal 314 and the fourth terminal 312 are exposed from the insulating film 104.

The insulating film 102 is deposited on the insulating film 104, the third terminal 314, and the fourth terminal 312 by a spin coating method. The insulating film 102 is selectively removed to expose the third terminal 314 and the fourth terminal 312 from the insulating film 102. In this manner, the first insulating layer 100 configured by the insulating films 102 and 104 is formed.

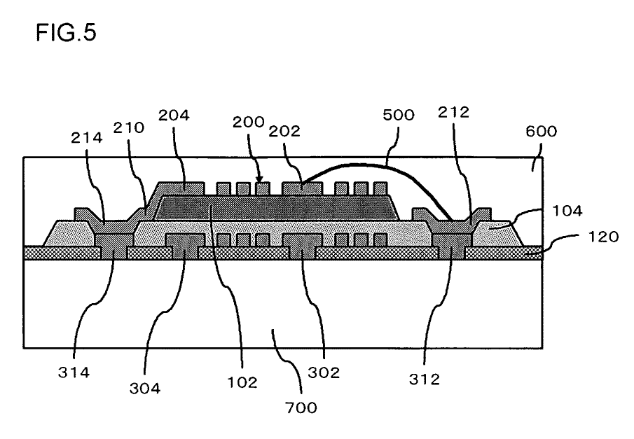

As shown in FIG. 5, a seed film (not shown) is deposited on the insulating film 102 (including side surfaces), the insulating film 104, the third terminal 314, and the fourth terminal 312. A resist pattern (not shown) is formed on the seed film. By using the resist pattern as a mask, plating is performed by using the seed film as a seed. In this manner, the first inductor 200, the first interconnect 210, the first terminal 214, and the second terminal 212 are formed. Thereafter, exposed portions of the resist pattern and the seed layer are removed. The surface layers of the first inductor 200, the first interconnect 210, the first terminal 214, and the second terminal 212 are preferably Au plating layers.

The central end 202 and the second terminal 212 of the first inductor 200 are connected to each other by the wire 500. The sealing resin layer 600 is formed to encapsulate the upper surface of the first insulating layer 100, the first inductor 200, the first terminal 214, the second terminal 212, and the wire 500 with a resin.

Thereafter, the support member 700 is removed from the second insulating layer 120. In this manner, the circuit apparatus 10 shown in FIGS. 1 and 2 is formed.

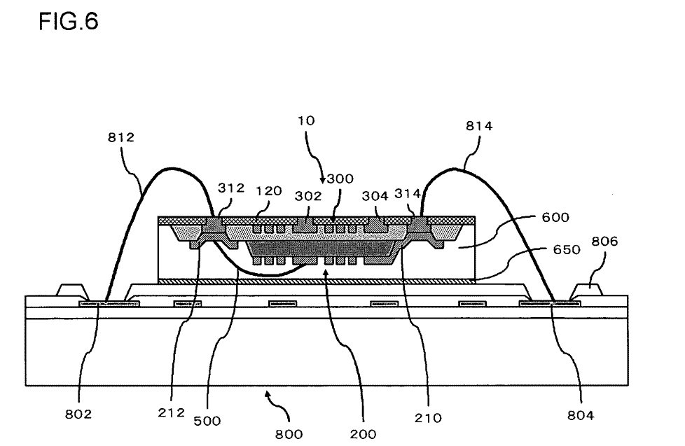

FIG. 6 is a cross-sectional view showing an example of a semiconductor device using the circuit apparatus 10. The semiconductor device is obtained by attaching the circuit apparatus 10 onto a surface having a pad of a semiconductor chip 800.

In the circuit apparatus 10, a one-surface side of the sealing resin layer 600 faces the semiconductor chip 800. The sealing resin layer 600 is fixed to a surface of a covering layer 806 formed as an uppermost layer of the semiconductor chip 800 by using an adhesive layer 650.

The third terminal 314, the fourth terminal 312, and the two ends 302 and 304 of the second inductor 300 are exposed from a surface opposing the semiconductor chip 800. These terminals and ends are connected to the semiconductor chip 800 or another semiconductor chip by wires. In FIG. 6, the third terminal 314 and the fourth terminal 312 are connected to terminals 802 and 804 of the semiconductor chip 800 through wires 812 and 814, respectively. For this reason, the semiconductor chip 800 is electrically connected to the first inductor 200. The two ends 302 and 304 of the second inductor 300 are connected to another semiconductor chip (not shown) through wires (not shown).

An operation and an effect of the embodiment will be described below. The central end 202 of the first inductor 200 is extracted from the first inductor 200 by the wire 500 and connected to the second terminal 212. So a interconnect layer to draw the end 202 from the first inductor 200 does not to be formed. The cost required to arrange the wire 500 is lower than the cost required to increase an interconnect layer. Therefore, the manufacturing cost of the circuit apparatus 10 can be suppressed from increasing.

The sealing resin layer 600 encapsulates the first inductor 200, the first terminal 214, the second terminal 212, the first interconnect 210, and the wire 500. So the reliability of the circuit apparatus 10 is improved. When a thickness T of the sealing resin layer 600 on the first inductor 200 is larger than the interconnect interval S of the first inductor 200, this effect is improved. When the thickness of the first insulating layer 100 is larger than the interconnect interval of the first inductor 200, the effect is improved. Since an epoxy resin can be used as the sealing resin layer 600, the manufacturing cost of the circuit apparatus 10 can be suppressed without using a special resin as the sealing resin layer 600.

The first inductor 200 faces the second inductor 300 through the first insulating layer 100. For this reason, an electric signal can be transmitted between the first inductor 200 and the second inductor 300.

The first insulating layer 100 has a structure in which the plurality of insulating films 102 and 104 are laminated. For this reason, the film thickness of the first insulating layer 100 can be increased, and a withstand voltage between the first inductor 200 and the second inductor 300 can be increased. In particular, in the embodiment, the insulating films 102 and 104 essentially consist of a polyimide resin. The insulating films 102 and 104 are deposited at a low manufacturing cost by a spin coating method. However, in this case, the film thickness of the first insulating layer 100 can be increased.

The third terminal 314, the fourth terminal 312, and the two ends 302 and 304 of the second inductor 300 are exposed from the other surface of the circuit apparatus 10, that is, the other surface of the second insulating layer 120. For this reason, the sealing resin layer 600 faces downward (for example, on the semiconductor chip 800 side), and the second insulating layer 120 faces upward, so that the third terminal 314, the fourth terminal 312, and the two ends 302 and 304 of the second inductor 300 can be connected to the semiconductor chip by using wires. When the other surface of the second insulating layer 120 is planar, the wires can be easily connected to the terminals.

The first inductor 200 and the second inductor 300 essentially consist of one element selected from the group consisting of gold, copper, nickel, titanium, titanium-tungsten, and chromium or an alloy containing two or more elements selected from the group. For this reason, the first inductor 200 and the second inductor 300 can be formed by a plating method.

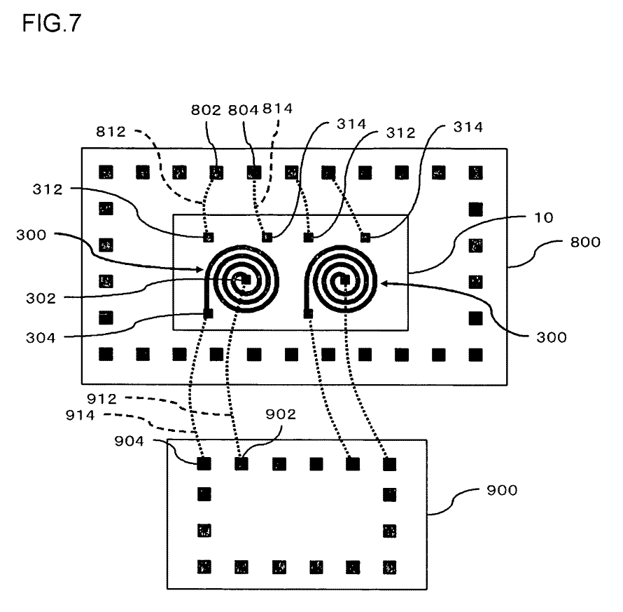

FIG. 7 is a plan view of a semiconductor device according to a second embodiment. The semiconductor device corresponds to the semiconductor device shown in FIG. 6 in the first embodiment. The semiconductor device in FIG. 7 is the same as the semiconductor device shown in FIG. 6 except for the following points.

The circuit apparatus 10 has a plurality of pairs (for example, two pairs) of first inductor 200 and second inductor 300. The plurality of first inductors 200 are connected to terminals 802 and 804 of the semiconductor chip 800 through the third terminal 314, the fourth terminal 312, and the wires 812 and 814, respectively.

The ends 302 and 304 of each of the plurality of second inductors 300 included in the circuit apparatus 10 are connected to terminals 902 and 904 of a semiconductor chip 900 through wires 912 and 914, respectively.

Also in this embodiment, the same effect as that in the first embodiment can be obtained. Since the circuit apparatus 10 has the plurality of pairs of first inductor 200 and second inductor 300, the semiconductor device can be miniaturized.

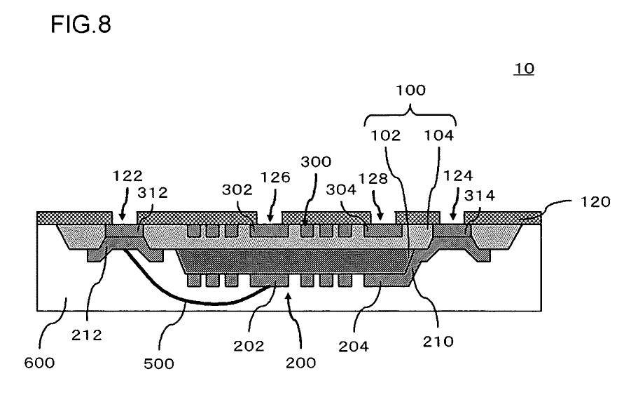

FIG. 8 is a cross-sectional view of a circuit apparatus 10 according to a third embodiment, and corresponds to FIG. 1 in the first embodiment. The circuit apparatus 10 according to the embodiment is the same as the first embodiment except that the third terminal 314, the fourth terminal 312, and the two ends 302 and 304 of the second inductor 300 are not buried in the openings 122, 124, 126, and 128 of the second insulating layer 120.

According to the embodiment, the same effect as that of the first embodiment can also be obtained. The semiconductor device shown in FIG. 6 in the first embodiment and the semiconductor device described in the second embodiment can be manufactured.

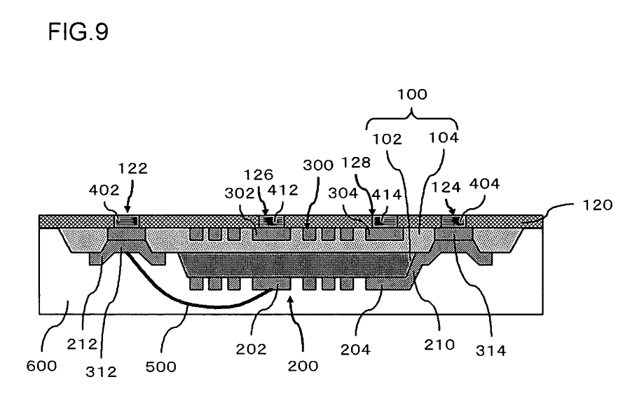

FIG. 9 is a cross-sectional view of a circuit apparatus 10 according to a fourth embodiment, and corresponds to FIG. 1 in the first embodiment. The circuit apparatus 10 according to the embodiment is the same as the circuit apparatus 10 described in the first embodiment except for the following points. The third terminal 314, the fourth terminal 312, and the two ends 302 and 304 of the second inductor 300 are not buried in the openings 122, 124, 126, and 128 of the second insulating layer 120, respectively. Electrodes 402, 404, 412, and 414 are buried in the openings 122, 124, 126, and 128, respectively. The electrodes 402, 404, 412, and 414 are connected to the fourth terminal 312, the third terminal 314, and the ends 302 and 304, respectively.

According to the embodiment, the same effect as that in the first embodiment can also be obtained. The semiconductor device shown in FIG. 6 in the first embodiment and the semiconductor device described in the second embodiment can be manufactured.

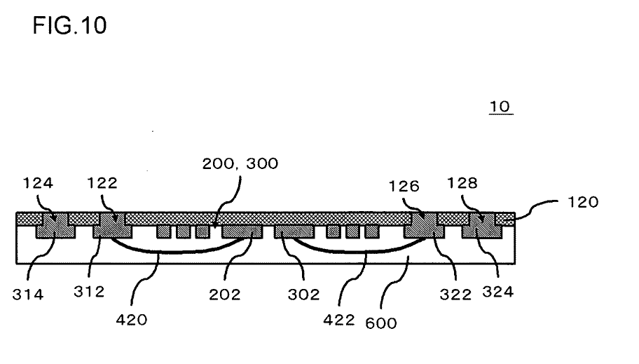

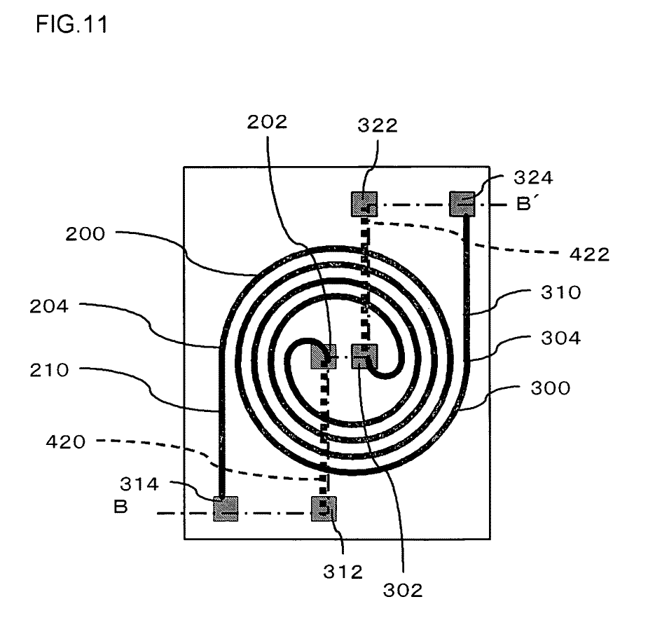

FIG. 10 is a cross-sectional view of a circuit apparatus 10 according to a fifth embodiment, and FIG. 11 is a plan view schematically showing the circuit apparatus 10 shown in FIG. 10. FIG. 10 corresponds to a cross-sectional view along a B-B′ line in FIG. 11. In the circuit apparatus 10 according to the embodiment, both the first inductor 200 and the second inductor 300 are formed on one surface of the second insulating layer 120. A conductive pattern constituting the second inductor 300 spirally extends in parallel to a conductive pattern constituting the first inductor 200.

The central end 202 of the first inductor 200 is connected to the fourth terminal 312 by a wire 420, and the first interconnect 210 connects the external end 204 of the first inductor 200 and the third terminal 314 to each other. The first inductor 200 and the first interconnect 210 are formed in the same step as that of the second inductor 300.

The two ends 302 and 304 of the second inductor 300 are formed at positions different from positions of the openings 126 and 128, and a sixth terminal 322 and a fifth terminal 324 are buried in the openings 126 and 128, respectively. The configurations of the fifth terminal 324 and the sixth terminal 322 are the same as those of the third terminal 314 and the fourth terminal 312. All of the third terminal 314, the fourth terminal 312, the fifth terminal 324, the sixth terminal 322, and the two ends 302 and 304 of the second inductor 300 are exposed from one surface and the other surface of the second insulating layer 120.

The central end 302 of the second inductor 300 is connected to the sixth terminal 322 by a wire 422, and the external end 304 of the second inductor 300 is connected to the fifth terminal 324 by a second interconnect 310. The second interconnect 310 is formed on one surface of the second insulating layer 120, that is, a surface on which the first inductor 200 and the second inductor 300 are formed.

The other surface of the second insulating layer 120 is a planar surface. One surface of the second insulating layer 120, the first inductor 200, the second inductor 300, the third terminal 314, the fourth terminal 312, the fifth terminal 324, the sixth terminal 322, and the wires 420 and 422 are encapsulated by the sealing resin layer 600.

A method of manufacturing a circuit apparatus according to the embodiment is as follows. The second insulating layer 120 and the openings 122, 124, 126, and 128 are formed on one surface of the support member 700. Methods of forming the layer and the openings are the same as those in the first embodiment. The first inductor 200, the second inductor 300, the third terminal 314, the fourth terminal 312, the fifth terminal 324, and the sixth terminal 322 are formed. Methods of forming the inductor and the terminals are the same as the methods of forming the second inductor 300, the third terminal 314, and the fourth terminal 312 in the first embodiment. The sealing resin layer 600 is formed. Thereafter, the support member 700 is removed from the second insulating layer 120.

According to the embodiment, the same effect as that in the first embodiment can be obtained. Since the number of layers of the circuit apparatus 10 is small, the circuit apparatus 10 can be made thin. The manufacturing cost of the circuit apparatus 10 reduces.

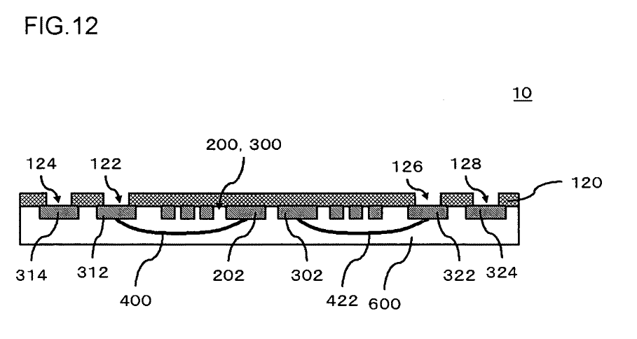

FIG. 12 is a cross-sectional view of a circuit apparatus 10 according to a sixth embodiment, and corresponds to FIG. 10 in the fifth embodiment. The circuit apparatus 10 according to the embodiment is the same as that in the fifth embodiment except that the third terminal 314, the fourth terminal 312, the fifth terminal 324, and the sixth terminal 322 are not buried in the openings 122, 124, 126, and 128 of the second insulating layer 120, respectively.

According to the embodiment, the same effect as that in the fifth embodiment can be obtained.

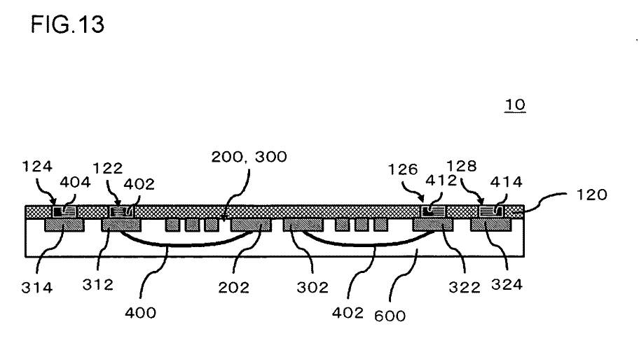

FIG. 13 is a cross-sectional view of a circuit apparatus 10 according to a seventh embodiment, and corresponds to FIG. 10 in the fifth embodiment. The circuit apparatus 10 according to the embodiment is the same as the circuit apparatus 10 described in the fifth embodiment except for the following points. The third terminal 314, the fourth terminal 312, the fifth terminal 324, and the sixth terminal 322 are not buried in the openings 122, 124, 126, and 128 of the second insulating layer 120. The electrodes 402, 404, 412, and 414 are buried in the openings 122, 124, 126, and 128, respectively. The electrodes 402, 404, 412, and 414 are connected to the fourth terminal 312, the third terminal 314, the sixth terminal 322, and the fifth terminal 324, respectively.

According to the embodiment, the same effect as that in the fifth embodiment can also be obtained.

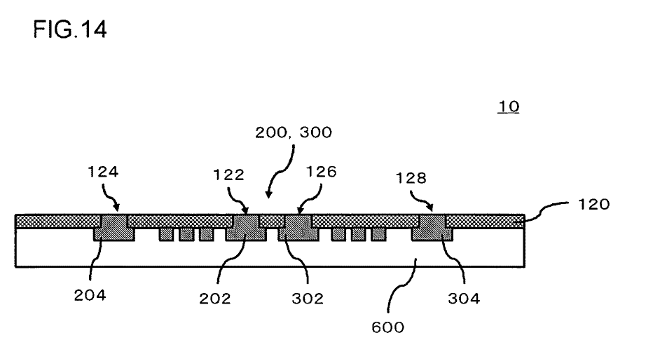

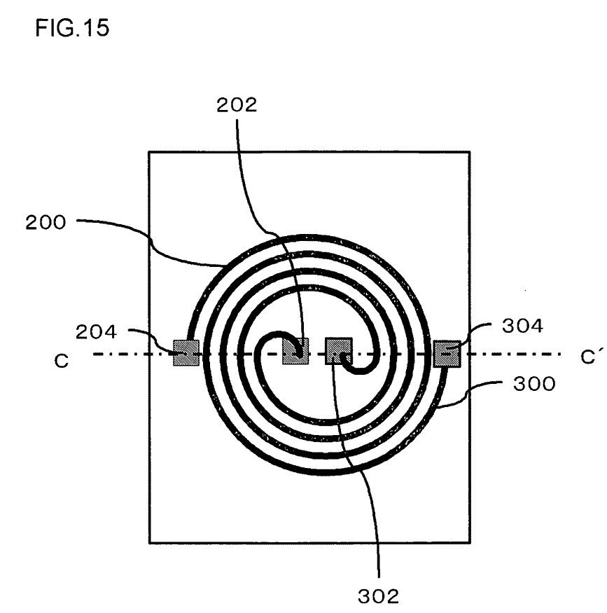

FIG. 14 is a cross-sectional view of a circuit apparatus 10 according to an eighth embodiment, and corresponds to FIG. 10 in the fifth embodiment. FIG. 15 is a plan view schematically showing the circuit apparatus 10 shown in FIG. 14, and corresponds to FIG. 11 in the fifth embodiment. FIG. 14 corresponds to a section along a C-C′ line in FIG. 15.

The circuit apparatus 10 according to the embodiment is the same as the circuit apparatus 10 described in the fifth embodiment except for the following points. The openings 122 and 124 overlap the two ends 202 and 204 of the first inductor 200, and the ends 202 and 204 are buried in the openings 122 and 124, respectively. The openings 126 and 128 overlap the two ends 302 and 304 of the second inductor 300, and the ends 302 and 304 are buried in the openings 126 and 128, respectively. The first interconnect 210 and the second interconnect 310 shown in FIG. 10 are not formed, and the wires 420 and 422 are not used.

According to the embodiment, the same effect as that in the fifth embodiment can also be obtained. Since a wire need not be used, the manufacturing cost of the circuit apparatus 10 further reduces.

In the embodiment, as in the sixth embodiment, the ends 202, 204, 302, and 304 may not be buried in the openings 122, 124, 126, and 128 of the second insulating layer 120, respectively. In this case, as in the seventh embodiment, electrodes may be buried in the openings 122, 124, 126, and 128. These electrodes are connected to the ends 202, 204, 302, and 304.

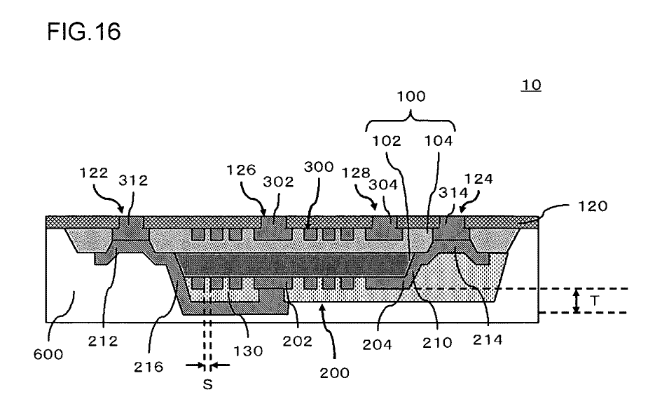

FIG. 16 is a cross-sectional view showing a configuration of a circuit apparatus 10 according to a ninth embodiment. The circuit apparatus 10 in the embodiment has the same configuration as that of the circuit apparatus 10 according to the first embodiment except that an insulating layer 130 and an interconnect 216 are arranged in place of the wire 500 and the second terminal 212 is formed in the same step as that of the interconnect 216.

The insulating layer 130 is formed on the first insulating layer 100, the first inductor 200, the first interconnect 210, and the first terminal 214. However, the insulating layer 130 does not cover the fourth terminal 312 and has an opening on the central end 202 of the first inductor 200. The interconnect 216 is formed at least on the insulating layer 130 and in the openings in the insulating layer 130 to connect the second terminal 212 and the end 202 of the first inductor 200 to each other.

A method of manufacturing the circuit apparatus 10 according to the embodiment is the same as that in the first embodiment except that, after the first inductor 200, the first interconnect 210, and the first terminal 214 are formed, the insulating layer 130 is formed, and the second terminal 212 and the interconnect 216 are formed. The step of forming the insulating layer 130 is almost the same as the step of depositing the insulating film 104. The step of forming the second terminal 212 and the interconnect 216 is almost the same as the step of forming the first inductor 200, the first interconnect 210 and the first terminal 214.

According to the embodiment, an electric signal can be transmitted between the first inductor 200 and the second inductor 300. As in the first embodiment, the film thickness of the first insulating layer 100 can be increased. As in the first embodiment, the third terminal 314, the fourth terminal 312, and the two ends 302 and 304 of the second inductor 300 can be easily connected to a semiconductor chip by using wires.

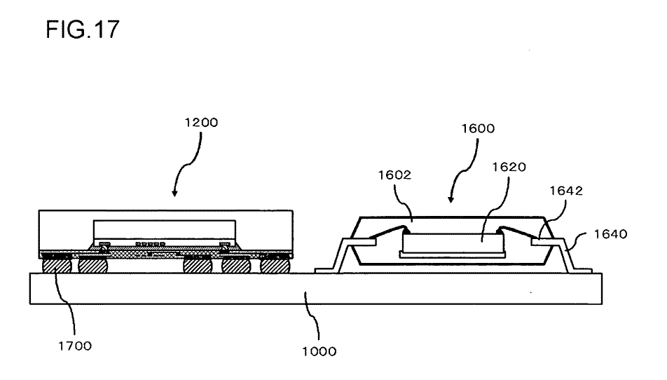

FIG. 17 is a cross-sectional view showing a configuration of a circuit apparatus according to a tenth embodiment. The circuit apparatus is obtained by mounting semiconductor devices 1200 and 1600 on a printed circuit board 1000 (for example, a mother board). The semiconductor device 1200 is mounted on the printed circuit board 1000 by using solder balls 1700. The semiconductor device 1600 is obtained by mounting a semiconductor chip 1620 on a lead frame 1640, and is mounted on the printed circuit board 1000 by using the lead frame 1640. Inner leads of the semiconductor chip 1620 and the lead frame 1640 are encapsulated by an sealing resin 1602.

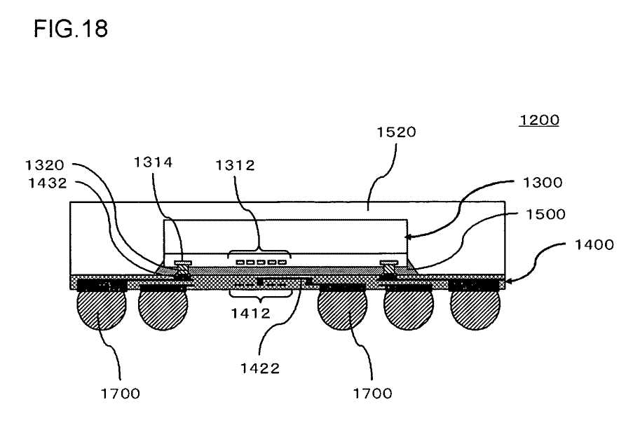

FIG. 18 is a cross-sectional view showing a configuration of the semiconductor device 1200. The semiconductor device 1200 has a semiconductor chip 1300 and an interposer substrate 1400. The semiconductor chip 1300 is mounted on one surface of the interposer substrate 1400 as a flip chip. A space between the semiconductor chip 1300 and the interposer substrate 1400 is encapsulated by an sealing resin 1500. An entire area of the semiconductor chip 1300 and one surface of the interposer substrate 1400 are encapsulated by an sealing resin 1520. Both the sealing resin 1500 and the sealing resin 1520 have insulating properties. On an opposite surface of the interposer substrate 1400, the solder balls 1700 are fixed.

The semiconductor chip 1300 has a multilayered interconnect and has a first inductor 1312 in any one of the interconnect layers. In the example shown in FIG. 18, the first inductor 1312 is formed in the same layer as that of a pad 1314. For this reason, a conductive pattern constituting the first inductor 1312 has a thickness larger than a thickness obtained when the first inductor 1312 is formed in another interconnect layer. Thus, the resistance of the first inductor 1312 decreases.

The first inductor 1312 is a spiral conductive pattern. An external end of the first inductor 1312 is connected to the pad 1314 through an interconnect (not shown) in the same layer as that of the first inductor 1312. A central end of the first inductor 1312 is extracted outside the first inductor 1312 through an interconnect (not shown) in a layer different from that of the first inductor 1312 and electrically connected to the pad 1314.

The pad 1314 of the semiconductor chip 1300 is connected to a connection terminal 1432 of the interposer substrate 1400 through a bump 1320. The interposer substrate 1400 has at least two interconnect layers, and electrically connects the connection terminal 1432 and the solder balls 1700 through the interconnect layers.

The interposer substrate 1400 has a second inductor 1412 in any one of the interconnect layers. The second inductor 1412 is a spiral conductive pattern. The second inductor 1412 faces the first inductor 1312. The second inductor 1412 is inductively coupled to the first inductor 1312 to mutually transmit an electric signal with the first inductor 1312. An external end of the second inductor 1412 is connected to the solder balls 1700 through an interconnect (not shown) in the same layer as that of the second inductor 1412. A central end of the second inductor 1412 is extracted outside the second inductor 1412 through an interconnect 1422 in a layer different from that of the second inductor 1412 and electrically connected to the solder balls 1700. For this reason, the two ends of the first inductor 1312 and the second inductor 1412 can be electrically connected to the printed circuit board 1000 shown in FIG. 17 through the solder balls 1700. For example, the second inductor 1412 is electrically connected to the semiconductor device 1600 shown in FIG. 17 through the printed circuit board 1000. In this case, the semiconductor device 1200 and the semiconductor device 1600 can mutually transmit an electric signal through the first inductor 1312 and the second inductor 1412.

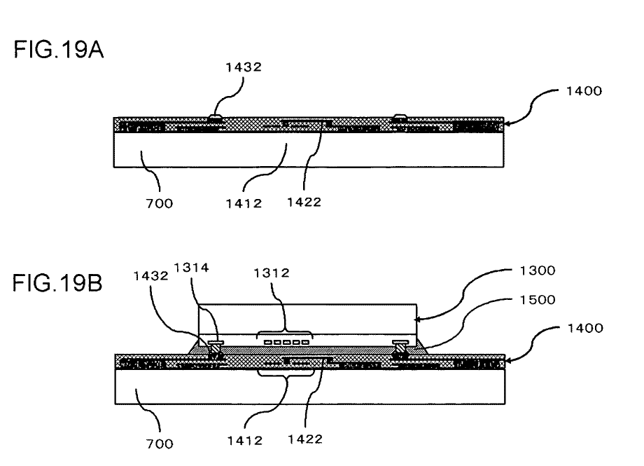

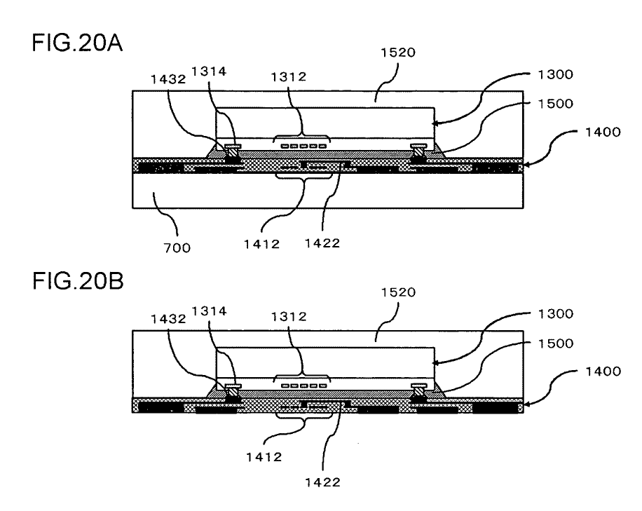

FIGS. 19A and 19B and FIGS. 20A and 20B are cross-sectional views showing a method of manufacturing the semiconductor device 1200 shown in FIG. 18. As shown in FIG. 19A, an insulating film is deposited on one surface of the support member 700 by a spin coating method. The insulating layer is selectively removed to form an opening. A seed layer (not shown) is formed on the insulating layer and in the opening by a sputtering method. A resist pattern (not shown) is formed on the seed film and, by using the resist pattern as a mask, plating is performed by using the seed film as a seed. In this manner, one interconnect layer is formed. Thereafter, the resist pattern is removed. The steps described above are repeated required times to form the interposer substrate 1400 on one surface of the support member 700. In this state, one surface of the interposer substrate 1400 on which the semiconductor chip 1300 is mounted is exposed.

As shown in FIG. 19B, the semiconductor chip 1300 is mounted on one surface of the interposer substrate 1400, and the sealing resin 1500 is arranged in a space between the semiconductor chip 1300 and one surface of the interposer substrate 1400. In this state, the first inductor 1312 and the second inductor 1412 face each other through the sealing resin 1500.

As shown in FIG. 20A, the semiconductor chip 1300 and one surface of the interposer substrate 1400 are encapsulated by using the sealing resin 1520.

As shown in FIG. 20B, the support member 700 is removed. Thereafter, the solder balls 1700 are fixed to the opposite surface of the interposer substrate 1400 to form the semiconductor device 1200 shown in FIG. 18.

According to the embodiment, an electric signal can be transmitted between the semiconductor chip 1300 and the semiconductor chip 1620 through the first inductor 1312 included in the semiconductor chip 1300 and the second inductor 1412 included in the interposer substrate 1400.

The first inductor 1312 is formed in the interconnect layer of the semiconductor chip 1300, and the second inductor 1412 is formed in the interconnect layer of the interposer substrate 1400. For this reason, the steps to form the first inductor 1312 and the second inductor 1412 need not be independently set.

An interconnect resistance of an interconnect held by the interposer substrate 1400 is smaller than an interconnect resistance of an interconnect held by the semiconductor chip. For this reason, the resistance of the second inductor 1412 is lower than the resistance of the first inductor 1312. Therefore, the second inductor 1412 is connected to a transmission circuit (not shown) which transmits a signal, and the first inductor 1312 is connected to a reception circuit (not shown) held by the semiconductor chip 1300, so that transmission efficiency of an electric signal can be improved.

At least the sealing resin 1500 is located between the first inductor 1312 and the second inductor 1412. For this reason, even though a potential difference between the first inductor 1312 and the second inductor 1412 is high, dielectric breakdown can be suppressed from occurring between the first inductor 1312 and the second inductor 1412. A distance between the first inductor 1312 and the second inductor 1412 can be easily adjusted by changing the height of the bump 1320.

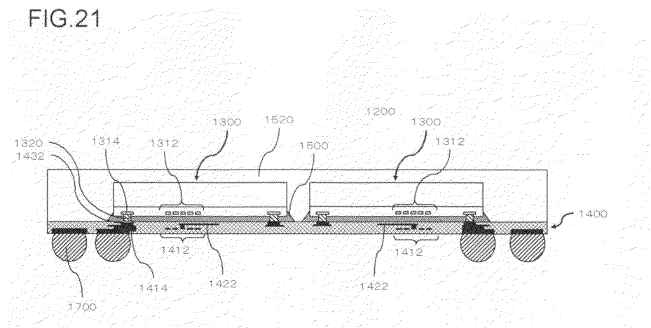

FIG. 21 is a cross-sectional view showing a configuration of a semiconductor device 1200 according to an eleven embodiment. FIG. 21 corresponds to FIG. 18 in the tenth embodiment. In the embodiment, the semiconductor device 1200 is the same as the semiconductor device 1200 according to the tenth embodiment except that a plurality of semiconductor chips 1300 are mounted on one interposer substrate 1400, and a plurality of second inductors 1412 corresponding to the plurality of semiconductor chips 1300, respectively, are formed on the interposer substrate 1400.

A method of manufacturing the semiconductor device 1200 according to the embodiment is almost the same as the method of manufacturing a semiconductor device according to the tenth embodiment. Although not shown, as in FIG. 17 in the tenth embodiment, the semiconductor device 1200 can be mounted on the printed circuit board 1000.

According to the embodiment, the same effect as that of the tenth embodiment can also be obtained. Since the semiconductor device 1200 has the plurality of semiconductor chips 1300, the number of parts to be mounted on the printed circuit board 1000 decreases, and the number of steps in manufacturing a circuit apparatus can be reduced.

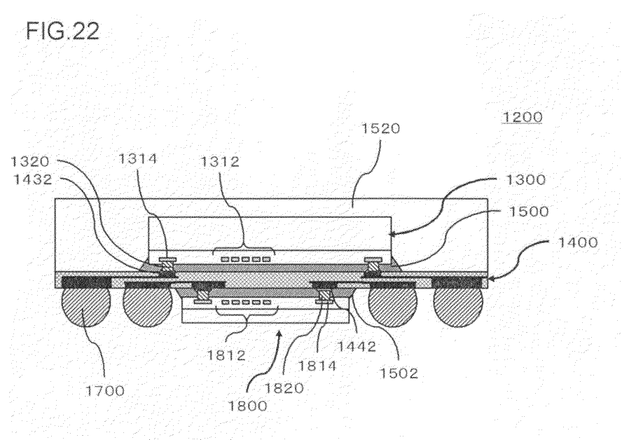

FIG. 22 is a cross-sectional view showing a configuration of a semiconductor device 1200 according to a twelfth embodiment. The semiconductor device 1200 has the same configuration as that of the semiconductor device 1200 according to the tenth embodiment except for the following points. On the interposer substrate 1400, the second inductor 1412 described in the tenth embodiment is not formed. A semiconductor chip 1800 is mounted as a flip chip on a surface, opposing the surface on which the semiconductor chip 1300 is mounted, of the interposer substrate 1400. A space between the opposite surface of the interposer substrate 1400 and the semiconductor chip 1800 is encapsulated by an sealing resin 1502.

The semiconductor chip 1800 has a second inductor 1812 serving as a spiral interconnect pattern. The second inductor 1812 faces the first inductor 1312 through the sealing resin 1502, the interposer substrate 1400, and the sealing resin 1500. A interconnect structure of the semiconductor chip 1800 is the same as that of the semiconductor device 1200, and the second inductor 1812 is formed in the same layer as that of a pad 1814. The pad 1814 is connected to a connection terminal 1442 of the interposer substrate 1400 through a bump 1820.

A method of manufacturing a semiconductor device according to the embodiment has the same configuration as the method of manufacturing a semiconductor device described in the tenth embodiment except that, after the sealing resin 1520 is formed and before the solder balls 1700 are fixed to the interposer substrate 1400, the semiconductor chip 1800 is mounted on the interposer substrate 1400, and the sealing resin 1502 is formed.

According to the embodiment, an electric signal can be transmitted between the semiconductor chip 1300 and the semiconductor chip 1800 through the first inductor 1312 held by the semiconductor chip 1300 and the second inductor 1812 held by the semiconductor chip 1800.

The first inductor 1312 is formed in the interconnect layer of the semiconductor chip 1300, and the second inductor 1812 is formed in the interconnect layer of the semiconductor chip 1800. For this reason, the steps to form the first inductor 1312 and the second inductor 1812 need not be independently set.

A distance between the first inductor 1312 and the second inductor 1812 can be easily adjusted by changing the heights of the bumps 1320 and 1820.

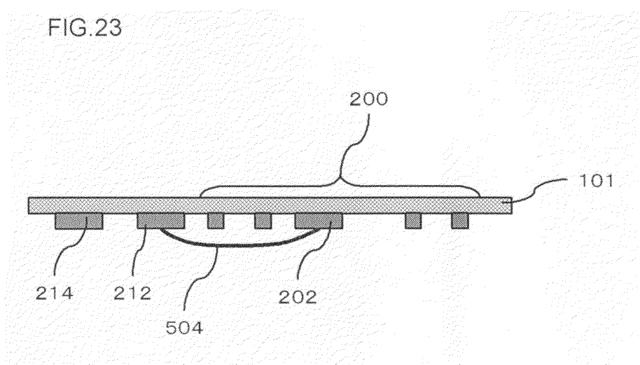

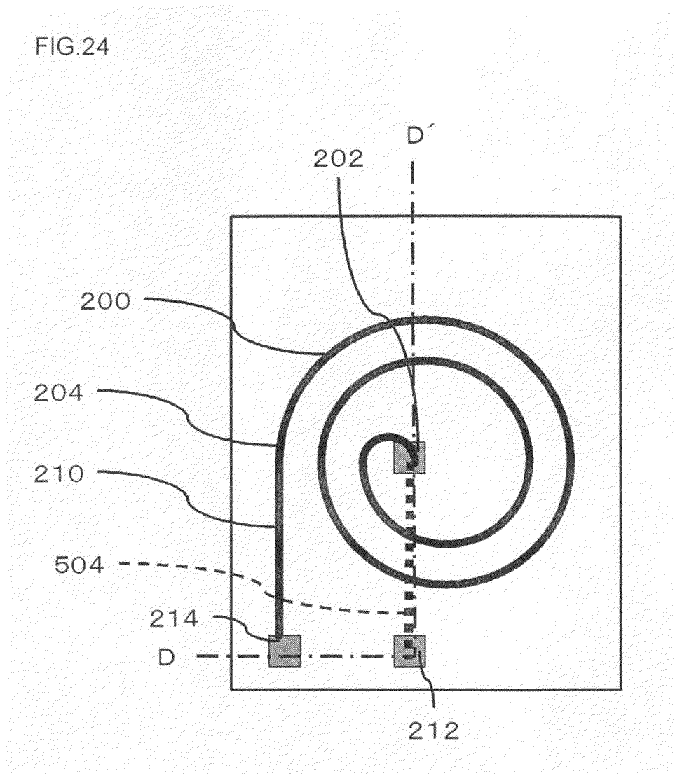

FIG. 23 is a cross-sectional view of a circuit apparatus according to a thirteenth embodiment. FIG. 24 is a plan view of the circuit apparatus shown in FIG. 23. FIG. 23 corresponds to a cross-sectional view along a D-D′ line in FIG. 24. The same reference symbols as in these drawings denote the same configurations in the first embodiment.

The circuit apparatus includes a first insulating layer 101, a first inductor 200, the first terminal 214, the second terminal 212, the first interconnect 210, and a wire 504. The first inductor 200 is located at one surface of the first insulating layer 101 and configured by a spiral conductive pattern. The first terminal 214 and the second terminal 212 are exposed from one surface of the first insulating layer 101. The first interconnect 210 is formed at one surface of the first insulating layer 101 to connect the first terminal 214 to the external end 204 of the first inductor 200. The wire 504 is located on one surface side of the first insulating layer 101 to connect the second terminal 212 and a central end 202 of the first inductor 200 to each other.

A method of manufacturing a circuit apparatus according to the embodiment is as follows. The first insulating layer 101 is formed. The first insulating layer 101 essentially consists of, for example, a polyimide resin. A conductive film is deposited on one surface of the first insulating layer 101. The conductive film is selectively removed to form the first inductor 202, the first interconnect 210, the first terminal 214, and the second terminal 212. The second terminal 212 and the end 202 are connected to each other by using the wire 504.

According to the embodiment, the central end 202 of the first inductor 200 is extracted from the first inductor 200 by the wire 504 and connected to the second terminal 212. For this reason, a interconnect layer to extract the end 202 from the first inductor 200 need not be deposited. The cost required to form the wire 504 is lower than the cost required to increase the number of interconnect layers. Therefore, the manufacturing cost of the circuit apparatus can be suppressed from increasing.

In the eighth embodiment described above, the following invention is disclosed.

A circuit apparatus including:

a first insulating layer;

a first inductor located at one surface of the first insulating layer and configured by a spiral conductive pattern;

a second inductor located at the one surface of the first insulating layer and configured by a conductive pattern spirally extending in parallel to the first inductor; and

four openings formed in the first insulating layer to expose two ends of the first inductor and two ends of the second inductor from the other surface side of the first insulating layer.

In the ninth embodiment described above, the following invention is disclosed.

A circuit apparatus including:

a first insulating layer;

a first inductor located at one surface of the first insulating layer and configured by a spiral conductive pattern;

a first terminal and a second terminal exposed from the one surface of the first insulating layer;

a first interconnect formed at the one surface of the first insulating layer to connect the first terminal and an external end of the first inductor;

a second insulating layer formed on the one surface of the first insulating layer and the first inductor;

an opening formed in the second insulating layer and located on a central end of the first inductor; and

a second interconnect formed at the one surface of the first insulating layer and the second insulating layer to connect the second terminal and the central end of the first inductor.

In the tenth to twelfth embodiments described above, the following invention is disclosed.

(1) A circuit apparatus including a semiconductor chip and a interconnect substrate on which the semiconductor chip is mounted as a flip chip,

wherein the semiconductor chip includes:

a chip-side interconnect layer; and

a first inductor formed in the chip-side interconnect layer and configured by a spiral conductive pattern, and

the interconnect substrate includes:

a substrate-side interconnect layer; and

a second inductor formed on the substrate-side interconnect layer, facing the first inductor, and configured by a spiral conductive pattern.

(2) The circuit apparatus described in the (1),

further including an sealing resin layer which encapsulates a space between the semiconductor chip and the interconnect substrate.

(3) The circuit apparatus described in the (1) or (2)

wherein the interconnect substrate is an interposer substrate.

(4) The circuit apparatus described in any one of the (1) to (3),

wherein the second inductor is connected to a transmission circuit,

the semiconductor chip has a reception circuit, and

the first inductor is connected to the reception circuit.

(5) A circuit apparatus including:

a interconnect substrate;

a first semiconductor chip mounted on one surface of the interconnect substrate as a flip chip; and

a second semiconductor chip mounted on a surface opposing the one surface of the interconnect substrate as a flip chip,

wherein the first semiconductor chip includes:

a first interconnect layer; and

a first inductor formed on the first interconnect layer and configured by a spiral conductive pattern, and

the second semiconductor chip includes:

a second interconnect layer; and

a second inductor formed on the second interconnect layer, facing the first inductor through the interconnect substrate, and configured by a spiral conductive pattern.

(6) A method of manufacturing a circuit apparatus, including:

preparing a semiconductor chip including a chip-side interconnect layer and a first inductor formed on the chip-side interconnect layer and configured by a spiral conductive pattern;

preparing a interconnect substrate including a substrate-side interconnect layer and a second inductor formed on the substrate-side interconnect layer and configured by a spiral conductive pattern; and

mounting the semiconductor chip on the interconnect substrate as a flip chip and causing the first inductor to face the second inductor.

(7) The method of manufacturing a circuit apparatus described in the (6), including:

after mounting the semiconductor chip on the interconnect substrate as a flip chip,

sealing a space between the interconnect substrate and the semiconductor chip with an sealing resin.

The embodiments of the present invention have been described with reference to the accompanying drawings. However, the embodiments are illustrations of the present invention, and various configurations other than the configurations described above can also be employed.

It is apparent that the present invention is not limited to the above embodiment, and may be modified and changed without departing from the scope and spirit of the invention.

What is claimed is:

1. A circuit apparatus comprising:
a first insulating layer;
a first inductor located at one surface of said first insulating layer and configured by a spiral conductive pattern;
a first terminal and a second terminal exposed from said one surface of said first insulating layer;
a first interconnect formed at said one surface of said first insulating layer to connect said first terminal and an external end of said first inductor; and
a first wire located on said one surface side of said first insulating layer to connect said second terminal and a central end of said first inductor.

2. The circuit apparatus according to claim 1, further comprising an sealing resin layer which encapsulates said one surface of said first insulating layer, said first inductor, said first terminal, said second terminal, said first interconnect, and said first wire.

3. The circuit apparatus according to claim 2,
wherein said sealing resin layer is an epoxy resin layer.

4. The circuit apparatus according to claim 2,
wherein a thickness of said sealing resin layer is larger than an interconnect interval of said first inductor.

5. The circuit apparatus according to claim 1, further comprising:
a second inductor located at said other surface of said first insulating layer and located in a region overlapping said first inductor in a direction perpendicular to said one surface;
a third terminal and a fourth terminal arranged on said other surface of said first insulating layer and connected to said first terminal and said second terminal, respectively;
a second insulating layer having one surface being in contact with said other surface of said first insulating layer and said second inductor; and
four openings formed in said second insulating layer to expose said third terminal, said fourth terminal, and two ends of said second inductor from other surface of said second insulating layer.

6. The circuit apparatus according to claim 5,
wherein said first insulating layer has a structure in which a plurality of insulating films are laminated.

7. The circuit apparatus as claimed in claim 5,
wherein said other surface of said second insulating layer is planar.

8. The circuit apparatus according to claim 5,
wherein a thickness of said first insulating layer is larger than an interconnect interval of said first inductor.

9. The circuit apparatus according to claim 5, further comprising:
a first semiconductor device; and
a third wire which connects said first semiconductor device, and said third terminal and said fourth terminal.

10. The circuit apparatus according to claim 9, further comprising:
a second semiconductor device; and
a fourth wire which connects said second semiconductor device and said two ends of said second inductor.

11. The circuit apparatus according to claim 9,
wherein said first insulating layer is located on said first semiconductor device, and said one surface of said first insulating layer faces said first semiconductor device.

12. The circuit apparatus according to claim 1,
wherein said first terminal and said second terminal are also exposed from said other surface of said first insulating layer, and
the circuit apparatus comprises:
a second inductor located on said one surface of said first insulating layer and configured by a conductive pattern spirally extending in parallel to said first inductor;
a fifth terminal and a sixth terminal exposed from said one surface and said other surface of said first insulating layer, respectively;
a second interconnect formed on said one surface of said first insulating layer to connect said fifth terminal and an external end of said second inductor; and
a second wire located on said one surface side of said first insulating layer to connect said sixth terminal and a central end of said second inductor.

13. The circuit apparatus according to claim 12,
wherein said other surface of said first insulating layer is planar.

14. The circuit apparatus according to claim 1,
wherein said first insulating layer essentially consists of a polyimide resin.

15. The circuit apparatus according to claim 1,
wherein said first inductor essentially consists of one element selected from the group consisting of gold, copper, nickel, titanium, titanium-tungsten, and chromium or laminated films or an alloy of at least two elements selected from the group.

16. A method of manufacturing a circuit apparatus, comprising:
forming a first insulating layer;
forming a first terminal and a second terminal exposed from said first insulating layer, a first inductor located on said first insulating layer, and an interconnect which connects an external end of said first inductor and said first terminal to each other; and
connecting said second terminal and a central end of said first inductor by using a wire.

17. The method of manufacturing a circuit apparatus according to claim 16, further comprising:
before said forming said first insulating layer,
forming a second insulating layer; and
forming a second inductor located in a region overlapping said first inductor on said second insulating layer,
wherein said forming said first insulating layer is forming said first insulating layer on said second insulating layer and said second inductor.

18. The method of manufacturing a circuit apparatus according to claim 17,
wherein said forming said second insulating layer is forming said second insulating layer on one surface of a support member,
the method comprises forming four third opening patterns located under said first terminal, said second terminal, and two ends of said second inductor in said second insulating layer by selectively removing said second insulating layer after said forming said second insulating layer and before said forming said second inductor,
said forming said first terminal, said second terminal, said first inductor, and said interconnect includes:
forming a first opening pattern and a second opening pattern in said first insulating layer; and
forming said first terminal in said first opening pattern, forming said second terminal in said second opening pattern, and forming said first inductor and said interconnect on said first insulating layer by selectively forming a conductive film on said first insulating layer, in said first opening pattern, and in said second opening pattern, and
the method comprises removing said support member from said second insulating layer after said connecting said second terminal and said central end of said first inductor by using said wire.

19. The method according to claim 16, further comprising:
after said connecting said second terminal and said central end of said first inductor by using said wire,
sealing an upper surface of said first insulating layer, said first inductor, said first terminal, said second terminal, and said wire with a resin.
